(19) United States
(12) Patent Application Publication
(10) Pub. No.: US 2023/0350420 A1
(43) Pub. Date: Nov. 2, 2023

(54) SYSTEMS AND METHODS FOR PRECISELY ESTIMATING A ROBOTIC FOOTPRINT FOR EXECUTION OF NEAR-COLLISION MOTIONS

(71) Applicant: Brain Corporation, San Diego, CA (US)

(72) Inventors: Kajal Gada, San Diego, CA (US); Abdolhamid Badiozamani, San Diego, CA (US); Oleg Sinavski, San Diego, CA (US); Jayram Moorkanikara-Nageswaran, San Diego, CA (US)

(21) Appl. No.: 18/215,335

(22) Filed: Jun. 28, 2023

Related U.S. Application Data
(63) Continuation of application No. PCT/US21/65292, filed on Dec. 28, 2021.
(60) Provisional application No. 63/131,643, filed on Dec. 29, 2020.

(51) Int. Cl. G05D 1/02; G06T 7/50; G06T 7/11

(52) U.S. Cl. CPC G05D 1/0246; G05D 1/0274; G05D 1/0214; G06T 7/50; G06T 7/11; G05D 2201/0203; G06T 2207/10028; G06T 2207/10024

(57) ABSTRACT

Systems and methods for precisely estimating a robotic footprint for execution of near-collision motions are disclosed herein. According to at least one non-limiting exemplary embodiment, a robot may switch from using a computer readable map to a sensor which senses at least a portion of the robot to navigate close by objects.

### PRIORITY

This application is a continuation of International Patent Application No. PCT/US21/65292 filed Dec. 28, 2021 and claims priority to U.S. provisional patent application No. 63/131,643 filed Dec. 29, 2020 under 35 U.S.C. § 119, the entire disclosure of which is incorporated herein by reference.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND

### Technological Field

The present application relates generally to robotics, and more specifically to systems and methods for precisely estimating a robotic footprint for execution of near-collision motions.

### SUMMARY

The foregoing needs are satisfied by the present disclosure, which provides for, inter alia, systems and methods for precisely estimating a robotic footprint for execution of near-collision motions.

Exemplary embodiments described herein have innovative features, no single one of which is indispensable or solely responsible for their desirable attributes. Without limiting the scope of the claims, some of the advantageous features will now be summarized. One skilled in the art would appreciate that as used herein, the term robot generally refers to an autonomous vehicle or object that travels a route, executes a task, or otherwise moves automatically upon executing or processing computer readable instructions.

According to at least one non-limiting exemplary embodiment, a robotic system is disclosed. The robotic system includes: a non-transitory computer readable storage medium having a plurality of instructions embodied thereon; and at least one controller configured to execute the instructions to: navigate the robotic system using a computer readable map, the computer readable map includes a footprint of the robotic system; receive sensor data from a sensor of the robotic system, the sensor includes a field of view which encompasses at least a portion of a body of the robotic system; detect the robotic system footprint is within a threshold distance to one or more objects localized on the map; detect a portion of the sensor data which sense the portion of the robotic system body within the field of view; determine a distance between the robotic system body and the object based on the portions of the sensor data which sense the robotic system body and the object; navigate the robotic system until the distance is below a threshold value, causing the robotic system to stop, or navigate the robotic system until the distance is above a threshold value.

According to at least one non-limiting exemplary embodiment, the sensor comprises a depth camera; the sensor data correspond to depth imagery; and the portion of the sensor data which senses the portion of the robotic system body corresponds to pixels of the depth imagery.

According to at least one non-limiting exemplary embodiment, the at least one controller is further configured to execute the instructions to: producing a pixel mask, the pixel mask corresponding to pixels of the depth imagery which depict the portion of the robotic system body within the field of view; and updating the pixel mask based on the receipt of at least one additional depth image.

According to at least one non-limiting exemplary embodiment, the distance between the robotic system body and the object is measured based on depth values of the depth imagery.

According to at least one non-limiting exemplary embodiment, the portion of the robotic system body is detected within the depth imagery using at least one of: (i) motion analysis between two or more successive depth images, wherein the portion of the robotic system body is stationary; (ii) pixel color analysis between two or more depth images, wherein pixels comprising a large color differential between the two or more images are determined to not correspond to the robotic system; or (iii) expected distances between the depth camera and the robotic system based on calibration values for the depth camera.

According to at least one non-limiting exemplary embodiment, the at least one controller is further configured to execute the instructions to: request human assistance using communications units of the robotic system, the request for assistance may include the robotic system performing at least one of: (i) emitting an auditory noise; (ii) emitting a visual indication; or (iii) transmitting a signal using a cellular or Wi-Fi network to a device of a human.

According to at least one non-limiting exemplary embodiment, the robotic system is a floor cleaning robot.

According to at least one non-limiting exemplary embodiment, a non-transitory computer readable storage medium having a plurality of instructions embodied thereon is disclosed. The instructions, when executed by at least one controller, causes the at least one controller to: navigate a robot using a computer readable map, the computer readable map includes a footprint of the robot; receive a depth image from a depth camera coupled to the robot, the depth camera includes a field of view which encompasses at least a portion of a body of the robot; detect the robot footprint is within a threshold distance to one or more objects localized on the map; detect a pixels of the depth image which correspond to the portion of the robot body within the field of view; produce a pixel mask, the pixel mask corresponding to the detected pixels of the depth imagery which correspond to the portion of the robot body within the field of view; and updating the pixel mask based on the receipt of at least one additional depth image; determine a distance between the robot body and the object based on the distance between the mask and the object; and navigate the robot until the distance is below a threshold value, causing the robot to stop; and request human assistance using communications units of the robot, the request for assistance may include the robot performing at least one of: (i) emitting an auditory noise; (ii) emitting a visual indication; or (iii) transmitting a signal using a cellular or Wi-Fi network to a device of a human, wherein, the distance between the robot body and the object is measured based on depth values of the depth imagery; the portion of the robot body is detected within the depth imagery using at least one of: (i) motion analysis between two or more successive depth images, wherein the portion of the robot body is stationary; (ii) pixel color analysis between two or more depth images, wherein pixels comprising a large color differential between the two or more images are determined to not correspond to the robot; or (iii) expected distances between the depth camera and the robot based on calibration values for the depth camera.

These and other objects, features, and characteristics of the present disclosure, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and in the claims, the singular form of “a”, “an”, and “the” include plural referents unless the context clearly dictates otherwise.

### BRIEF DESCRIPTION OF THE DRAWINGS

The disclosed aspects will hereinafter be described in conjunction with the appended drawings, provided to illustrate and not to limit the disclosed aspects, wherein like designations denote like elements.

FIG. 1A is a functional block diagram of a robot in accordance with some embodiments of this disclosure.

FIG. 1B is a functional block diagram of a controller or processor in accordance with some embodiments of this disclosure.

FIG. 2 is a computer readable map, according to an exemplary embodiment.

FIG. 3 illustrates discrepancies between a robotic footprint on a computer readable map and a robot body shape, according to an exemplary embodiment.

FIG. 4A illustrates a sensor configuration comprising sensors which sense a portion of a robot body, according to an exemplary embodiment.

FIG. 4B-D are computer aided design (“CAD”) models of a robot comprising a sensor which senses a portion of the robot body, according to an exemplary embodiment.

FIG. 5 is a process flow diagram illustrating a method for a controller of a robot to navigate close to objects, according to an exemplary embodiment.

FIG. 6 illustrates an image and a masked image, the mask denoting portions of the image which depict the robot body, according to an exemplary embodiment.

FIG. 7 illustrates a buffer zone surrounding a robot footprint, according to an exemplary embodiment.

FIG. 8A illustrates a computer readable map produced by a controller of a robot during navigation of a tight turn into a narrow passageway, according to an exemplary embodiment.

FIG. 8B illustrates a top-down view of a robot navigating a tight turn into a narrow passageway to show how an overestimation of a robotic footprint may cause a robot to stop navigating when the robot is able to continue, according to an exemplary embodiment.

FIG. 8C illustrates a controller of a robot using a mask to determine a true distance between the robot and a nearby object, according to an exemplary embodiment.

FIG. 9 is a process flow diagram illustrating a method for a controller of a robot to safely navigate close to objects using visual distance, according to an exemplary embodiment.

All Figures disclosed herein are © Copyright 2021 Brain Corporation. All rights reserved.

### DETAILED DESCRIPTION

Currently, many robots utilize computer readable maps to perceive their environments and navigate accordingly. These maps may include any detected objects and a footprint of a robot. The footprint represents approximately the area occupied by the robot on the map. These footprints often over-estimate the size of the robot for safety margins and/or to reduce computational complexity for motion planning. To plan motions of the robot, a controller or processor thereof may be required to simulate future positions of the footprint to determine viable (e.g., collision-free) motions for the robot, wherein use of a footprint comprising a complex shape which precisely denotes the shape of the robot is often impractical. Further, imperfections in localization may cause portions of the robot body to protrude from the footprint if the footprint does not overestimate the size/shape of the robot. Controllers of the robots may, using these maps and footprints thereon, determine a robot is colliding or nearly colliding with an object based on the footprint being overlapping with or within a threshold distance to an object on the map. This may cause the controller to stop the robot when, in actuality, the robot has enough clearance between itself and the object to continue navigating safely. Accordingly, the systems and methods of the present disclosure enable robots to utilize over-estimated footprints to navigate, e.g., for safety, while enabling the robots to estimate their size and shape more precisely during near-collision events.

Various aspects of the novel systems, apparatuses, and methods disclosed herein are described more fully hereinafter with reference to the accompanying drawings. This disclosure can, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art would appreciate that the scope of the disclosure is intended to cover any aspect of the novel systems, apparatuses, and methods disclosed herein, whether implemented independently of, or combined with, any other aspect of the disclosure. For example, an apparatus may be implemented or a method may be practiced using any number of the aspects set forth herein. In addition, the scope of the disclosure is intended to cover such an apparatus or method that is practiced using other structure, functionality, or structure and functionality in addition to or other than the various aspects of the disclosure set forth herein. It should be understood that any aspect disclosed herein may be implemented by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, and/or objectives. The detailed description and drawings are merely illustrative of the disclosure rather than limiting, the scope of the disclosure being defined by the appended claims and equivalents thereof.

The present disclosure provides for systems and methods for precisely estimating a robotic footprint for execution of near-collision motions. As used herein, a robot may include mechanical and/or virtual entities configured to carry out a complex series of tasks or actions autonomously. In some exemplary embodiments, robots may be machines that are guided and/or instructed by computer programs and/or electronic circuitry. In some exemplary embodiments, robots may include electro-mechanical components that are configured for navigation, where the robot may move from one location to another. Such robots may include autonomous and/or semi-autonomous cars, floor cleaners, rovers, drones, planes, boats, carts, trams, wheelchairs, industrial equipment, stocking machines, mobile platforms, personal transportation devices (e.g., hover boards, scooters, self-balancing vehicles such as manufactured by Segway, etc.),), trailer movers, vehicles, and the like. Robots may also include any autonomous and/or semi-autonomous machine for transporting items, people, animals, cargo, freight, objects, luggage, and/or anything desirable from one location to another.

As used herein, network interfaces may include any signal, data, or software interface with a component, network, or process including, without limitation, those of the FireWire (e.g., FW400, FW800, FWS800T, FWS1600, FWS3200, etc.), universal serial bus (“USB”) (e.g., USB 1.X, USB 2.0, USB 3.0, USB Type-C, etc.), Ethernet (e.g., 10/100, 10/100/1000 (Gigabit Ethernet), 10-Gig-E, etc.), multimedia over coax alliance technology (“MoCA”), Coaxsys (e.g., TVNET™), radio frequency tuner (e.g., in-band or OOB, cable modem, etc.), Wi-Fi (802.11), WiMAX (e.g., WiMAX (802.16)), PAN (e.g., PAN/802.15), cellular (e.g., 3G, 4G, 5G, LTE/LTE-A/TD-LTE/TD-LTE, GSM, etc.), IrDA families, etc. As used herein, Wi-Fi may include one or more of IEEE-Std. 802.11, variants of IEEE-Std. 802.11, standards related to IEEE-Std. 802.11 (e.g., 802.11 a/b/g/n/ac/ad/af/ah/ai/aj/aq/ax/ay), and/or other wireless standards.

As used herein, processor, microprocessor, and/or digital processor may include any type of digital processing device such as, without limitation, digital signal processors (“DSPs”), reduced instruction set computers (“RISC”), complex instruction set computers (“CISC”) processors, microprocessors, gate arrays (e.g., field programmable gate arrays (“FPGAs”)), programmable logic device (“PLDs”), reconfigurable computer fabrics (“RCFs”), array processors, secure microprocessors, and application-specific integrated circuits (“ASICs”). Such digital processors may be contained on a single unitary integrated circuit die or distributed across multiple components.

As used herein, computer program and/or software may include any sequence or human or machine cognizable steps which perform a function. Such computer program and/or software may be rendered in any programming language or environment including, for example, C/C++, C #, Fortran, COBOL, MATLAB™, PASCAL, GO, RUST, SCALA, Python, assembly language, markup languages (e.g., HTML, SGML, XML, VoXML), and the like, as well as object-oriented environments such as the Common Object Request Broker Architecture (“CORBA”), JAVA™ (including J2ME, Java Beans, etc.), Binary Runtime Environment (e.g., “BREW”), and the like.

As used herein, connection, link, and/or wireless link may include a causal link between any two or more entities (whether physical or logical/virtual), which enables information exchange between the entities.

As used herein, computer and/or computing device may include, but are not limited to, personal computers (“PCs”) and minicomputers, whether desktop, laptop, or otherwise, mainframe computers, workstations, servers, personal digital assistants (“PDAs”), handheld computers, embedded computers, programmable logic devices, personal communicators, tablet computers, mobile devices, portable navigation aids, J2ME equipped devices, cellular telephones, smart phones, personal integrated communication or entertainment devices, and/or any other device capable of executing a set of instructions and processing an incoming data signal.

Detailed descriptions of the various embodiments of the system and methods of the disclosure are now provided. While many examples discussed herein may refer to specific exemplary embodiments, it will be appreciated that the described systems and methods contained herein are applicable to any kind of robot. Myriad other embodiments or uses for the technology described herein would be readily envisaged by those having ordinary skill in the art, given the contents of the present disclosure.

Advantageously, the systems and methods of this disclosure at least: (i) reduce occurrence of robot stoppages due to near collision with objects; (ii) enable robots to precisely execute difficult near-collision maneuvers; (iii) reduce the rate at which robots require assistance from humans; and (iv) improve robotic workflows by enabling robots to execute difficult maneuvers. Other advantages are readily discernable by one having ordinary skill in the art given the contents of the present disclosure.

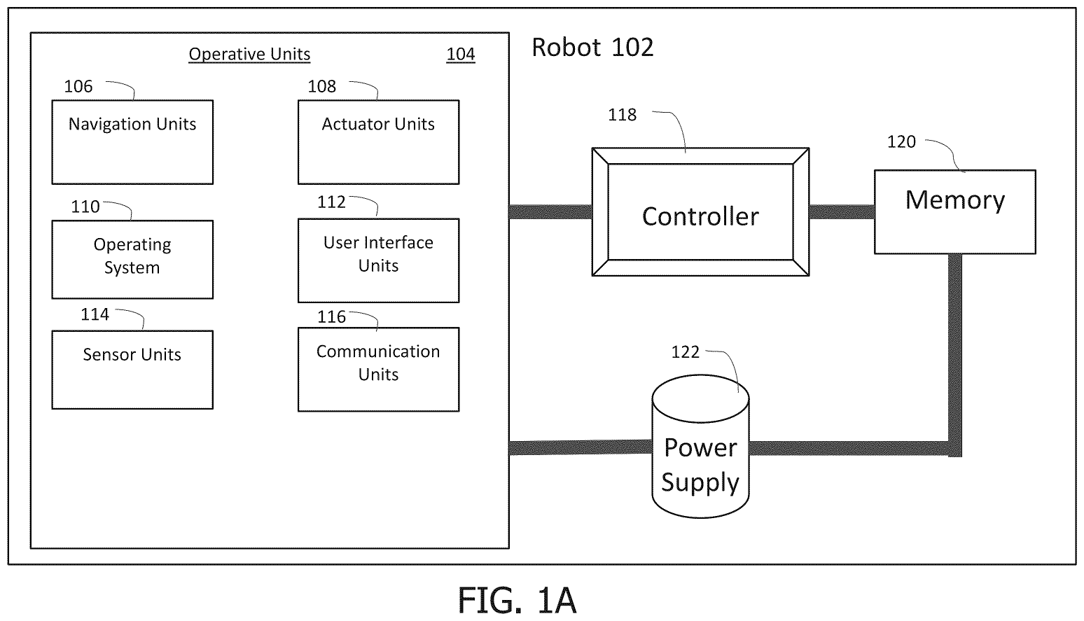

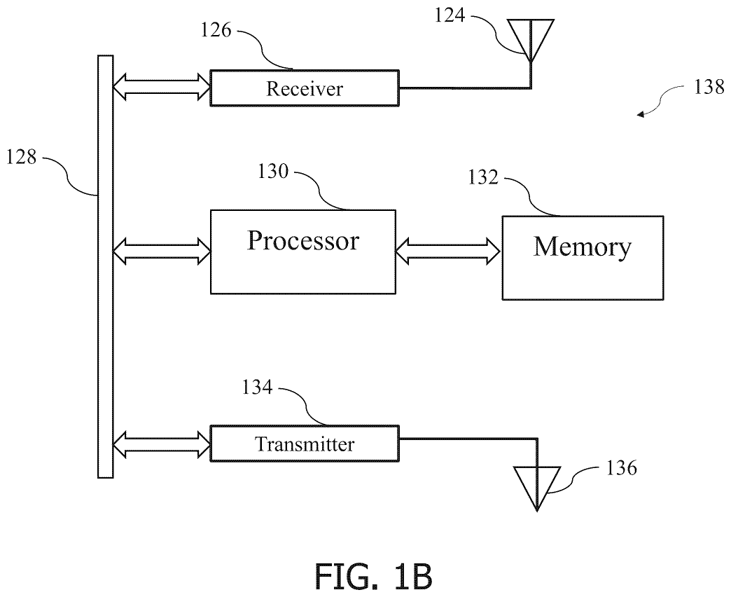

FIG. 1A is a functional block diagram of a robot 102 in accordance with some principles of this disclosure. As illustrated in FIG. 1A, robot 102 may include controller 118, memory 120, user interface unit 112, sensor units 114, navigation units 106, actuator unit 108, and communications unit 116, as well as other components and subcomponents (e.g., some of which may not be illustrated). Although a specific embodiment is illustrated in FIG. 1A, it is appreciated that the architecture may be varied in certain embodiments as would be readily apparent to one of ordinary skill given the contents of the present disclosure. As used herein, robot 102 may be representative at least in part of any robot described in this disclosure.

Controller 118 may control the various operations performed by robot 102. Controller 118 may include and/or comprise one or more processors (e.g., microprocessors) and other peripherals. As previously mentioned and used herein, processor, microprocessor, and/or digital processor may include any type of digital processing device such as, without limitation, digital signal processors (“DSPs”), reduced instruction set computers (“RISC”), complex instruction set computers (“CISC”), microprocessors, gate arrays (e.g., field programmable gate arrays (“FPGAs”)), programmable logic device (“PLDs”), reconfigurable computer fabrics (“RCFs”), array processors, secure microprocessors and application-specific integrated circuits (“ASICs”). Peripherals may include hardware accelerators configured to perform a specific function using hardware elements such as, without limitation, encryption/description hardware, algebraic processors (e.g., tensor processing units, quadratic problem solvers, multipliers, etc.), data compressors, encoders, arithmetic logic units (“ALU”), and the like. Such digital processors may be contained on a single unitary integrated circuit die, or distributed across multiple components.

Controller 118 may be operatively and/or communicatively coupled to memory 120. Memory 120 may include any type of integrated circuit or other storage device configured to store digital data including, without limitation, read-only memory (“ROM”), random access memory (“RAM”), non-volatile random access memory (“NVRAM”), programmable read-only memory (“PROM”), electrically erasable programmable read-only memory (“EEPROM”), dynamic random-access memory (“DRAM”), Mobile DRAM, synchronous DRAM (“SDRAM”), double data rate SDRAM (“DDR/2 SDRAM”), extended data output (“EDO”) RAM, fast page mode RAM (“FPM”), reduced latency DRAM (“RLDRAM”), static RAM (“SRAM”), flash memory (e.g., NAND/NOR), memristor memory, pseudostatic RAM (“PSRAM”), etc. Memory 120 may provide instructions and data to controller 118. For example, memory 120 may be a non-transitory, computer-readable storage apparatus and/or medium having a plurality of instructions stored thereon, the instructions being executable by a processing apparatus (e.g., controller 118) to operate robot 102. In some cases, the instructions may be configured to, when executed by the processing apparatus, cause the processing apparatus to perform the various methods, features, and/or functionality described in this disclosure. Accordingly, controller 118 may perform logical and/or arithmetic operations based on program instructions stored within memory 120. In some cases, the instructions and/or data of memory 120 may be stored in a combination of hardware, some located locally within robot 102, and some located remote from robot 102 (e.g., in a cloud, server, network, etc.).

It should be readily apparent to one of ordinary skill in the art that a processor may be internal to or on board robot 102 and/or may be external to robot 102 and be communicatively coupled to controller 118 of robot 102 utilizing communication units 116 wherein the external processor may receive data from robot 102, process the data, and transmit computer-readable instructions back to controller 118. In at least one non-limiting exemplary embodiment, the processor may be on a remote server (not shown).

In some exemplary embodiments, memory 120, shown in FIG. 1A, may store a library of sensor data. In some cases, the sensor data may be associated at least in part with objects and/or people. In exemplary embodiments, this library may include sensor data related to objects and/or people in different conditions, such as sensor data related to objects and/or people with different compositions (e.g., materials, reflective properties, molecular makeup, etc.), different lighting conditions, angles, sizes, distances, clarity (e.g., blurred, obstructed/occluded, partially off frame, etc.), colors, surroundings, and/or other conditions. The sensor data in the library may be taken by a sensor (e.g., a sensor of sensor units 114 or any other sensor) and/or generated automatically, such as with a computer program that is configured to generate/simulate (e.g., in a virtual world) library sensor data (e.g., which may generate/simulate these library data entirely digitally and/or beginning from actual sensor data) from different lighting conditions, angles, sizes, distances, clarity (e.g., blurred, obstructed/occluded, partially off frame, etc.), colors, surroundings, and/or other conditions. The number of images in the library may depend at least in part on one or more of the amount of available data, the variability of the surrounding environment in which robot 102 operates, the complexity of objects and/or people, the variability in appearance of objects, physical properties of robots, the characteristics of the sensors, and/or the amount of available storage space (e.g., in the library, memory 120, and/or local or remote storage). In exemplary embodiments, at least a portion of the library may be stored on a network (e.g., cloud, server, distributed network, etc.) and/or may not be stored completely within memory 120. As yet another exemplary embodiment, various robots (e.g., that are commonly associated, such as robots by a common manufacturer, user, network, etc.) may be networked so that data captured by individual robots are collectively shared with other robots. In such a fashion, these robots may be configured to learn and/or share sensor data in order to facilitate the ability to readily detect and/or identify errors and/or assist events.

Still referring to FIG. 1A, operative units 104 may be coupled to controller 118, or any other controller, to perform the various operations described in this disclosure. One, more, or none of the modules in operative units 104 may be included in some embodiments. Throughout this disclosure, reference may be to various controllers and/or processors. In some embodiments, a single controller (e.g., controller 118) may serve as the various controllers and/or processors described. In other embodiments different controllers and/or processors may be used, such as controllers and/or processors used particularly for one or more operative units 104. Controller 118 may send and/or receive signals, such as power signals, status signals, data signals, electrical signals, and/or any other desirable signals, including discrete and analog signals to operative units 104. Controller 118 may coordinate and/or manage operative units 104, and/or set timings (e.g., synchronously or asynchronously), turn off/on control power budgets, receive/send network instructions and/or updates, update firmware, send interrogatory signals, receive and/or send statuses, and/or perform any operations for running features of robot 102.

Returning to FIG. 1A, operative units 104 may include various units that perform functions for robot 102. For example, operative units 104 includes at least navigation units 106, actuator units 108, user interface units 112, sensor units 114, and communication units 116. Operative units 104 may also comprise other units such as specifically configured task units (not shown) that provide the various functionality of robot 102. In exemplary embodiments, operative units 104 may be instantiated in software, hardware, or both software and hardware. For example, in some cases, units of operative units 104 may comprise computer implemented instructions executed by a controller. In exemplary embodiments, units of operative unit 104 may comprise hardcoded logic (e.g., ASICS). In exemplary embodiments, units of operative units 104 may comprise both computer-implemented instructions executed by a controller and hardcoded logic. Where operative units 104 are implemented in part in software, operative units 104 may include units/modules of code configured to provide one or more functionalities.

In exemplary embodiments, navigation units 106 may include systems and methods that may computationally construct and update a map of an environment, localize robot 102 (e.g., find the position) in a map, and navigate robot 102 to/from destinations. The mapping may be performed by imposing data obtained in part by sensor units 114 into a computer-readable map representative at least in part of the environment. In exemplary embodiments, a map of an environment may be uploaded to robot 102 through user interface units 112, uploaded wirelessly or through wired connection, or taught to robot 102 by a user.

In exemplary embodiments, navigation units 106 may include components and/or software configured to provide directional instructions for robot 102 to navigate. Navigation units 106 may process maps, routes, and localization information generated by mapping and localization units, data from sensor units 114, and/or other operative units 104.

Still referring to FIG. 1A, actuator units 108 may include actuators such as electric motors, gas motors, driven magnet systems, solenoid/ratchet systems, piezoelectric systems (e.g., inchworm motors), magnetostrictive elements, gesticulation, and/or any way of driving an actuator known in the art. By way of illustration, such actuators may actuate the wheels for robot 102 to navigate a route; navigate around obstacles; or repose cameras and sensors. According to exemplary embodiments, actuator unit 108 may include systems that allow movement of robot 102, such as motorize propulsion. For example, motorized propulsion may move robot 102 in a forward or backward direction, and/or be used at least in part in turning robot 102 (e.g., left, right, and/or any other direction). By way of illustration, actuator unit 108 may control if robot 102 is moving or is stopped and/or allow robot 102 to navigate from one location to another location.

Actuator unit 108 may also include any system used for actuating, in some cases actuating task units to perform tasks. For example, actuator unit 108 may include driven magnet systems, motors/engines (e.g., electric motors, combustion engines, steam engines, and/or any type of motor/engine known in the art), solenoid/ratchet system, piezoelectric system (e.g., an inchworm motor), magnetostrictive elements, gesticulation, and/or any actuator known in the art.

According to exemplary embodiments, sensor units 114 may comprise systems and/or methods that may detect characteristics within and/or around robot 102. Sensor units 114 may comprise a plurality and/or a combination of sensors. Sensor units 114 may include sensors that are internal to robot 102 or external, and/or have components that are partially internal and/or partially external. In some cases, sensor units 114 may include one or more exteroceptive sensors, such as sonars, light detection and ranging (“LiDAR”) sensors, radars, lasers, cameras (including video cameras (e.g., red-blue-green (“RBG”) cameras, infrared cameras, three-dimensional (“3D”) cameras, thermal cameras, etc.), time of flight (“ToF”) cameras, structured light cameras, antennas, motion detectors, microphones, and/or any other sensor known in the art. According to some exemplary embodiments, sensor units 114 may collect raw measurements (e.g., currents, voltages, resistances, gate logic, etc.) and/or transformed measurements (e.g., distances, angles, detected points in obstacles, etc.). In some cases, measurements may be aggregated and/or summarized. Sensor units 114 may generate data based at least in part on distance or height measurements. Such data may be stored in data structures, such as matrices, arrays, queues, lists, arrays, stacks, bags, etc.

According to exemplary embodiments, sensor units 114 may include sensors that may measure internal characteristics of robot 102. For example, sensor units 114 may measure temperature, power levels, statuses, and/or any characteristic of robot 102. In some cases, sensor units 114 may be configured to determine the odometry of robot 102. For example, sensor units 114 may include proprioceptive sensors, which may comprise sensors such as accelerometers, inertial measurement units (“IMU”), odometers, gyroscopes, speedometers, cameras (e.g. using visual odometry), clock/timer, and the like. Odometry may facilitate autonomous navigation and/or autonomous actions of robot 102. This odometry may include robot's 102 position (e.g., where position may include robot's location, displacement and/or orientation, and may sometimes be interchangeable with the term pose as used herein) relative to the initial location. Such data may be stored in data structures, such as matrices, arrays, queues, lists, arrays, stacks, bags, etc. According to exemplary embodiments, the data structure of the sensor data may be called an image.

According to exemplary embodiments, sensor units 114 may be at least in part external to the robot 102 and coupled to communications units 116. For example, a security camera within an environment of a robot 102 may provide a controller 118 of the robot 102 with a video feed via wired or wireless communication channel(s). In some instances, sensor units 114 may include sensors configured to detect a presence of an object at a location such as, for example without limitation, a pressure or motion sensor may be disposed at a shopping cart storage location of a grocery store, wherein the controller 118 of the robot 102 may utilize data from the pressure or motion sensor to determine if the robot 102 should retrieve more shopping carts for customers.

According to exemplary embodiments, user interface units 112 may be configured to enable a user to interact with robot 102. For example, user interface units 112 may include touch panels, buttons, keypads/keyboards, ports (e.g., universal serial bus (“USB”), digital visual interface (“DVI”), Display Port, eSATA, Firewire, PS/2, Serial, VGA, SCSI, audioport, high-definition multimedia interface (“HDMI”), personal computer memory card international association (“PCMCIA”) ports, memory card ports (e.g., secure digital (“SD”) and miniSD), and/or ports for computer-readable medium), mice, rollerballs, consoles, vibrators, audio transducers, and/or any interface for a user to input and/or receive data and/or commands, whether coupled wirelessly or through wires. Users may interact through voice commands or gestures. User interface units 218 may include a display, such as, without limitation, liquid crystal display (“LCDs”), light-emitting diode (“LED”) displays, LED LCD displays, in-plane-switching (“IPS”) displays, cathode ray tubes, plasma displays, high definition (“HD”) panels, 4K displays, retina displays, organic LED displays, touchscreens, surfaces, canvases, and/or any displays, televisions, monitors, panels, and/or devices known in the art for visual presentation. According to exemplary embodiments user interface units 112 may be positioned on the body of robot 102. According to exemplary embodiments, user interface units 112 may be positioned away from the body of robot 102 but may be communicatively coupled to robot 102 (e.g., via communication units including transmitters, receivers, and/or transceivers) directly or indirectly (e.g., through a network, server, and/or a cloud). According to exemplary embodiments, user interface units 112 may include one or more projections of images on a surface (e.g., the floor) proximally located to the robot, e.g., to provide information to the occupant or to people around the robot. The information could be the direction of future movement of the robot, such as an indication of moving forward, left, right, back, at an angle, and/or any other direction. In some cases, such information may utilize arrows, colors, symbols, etc.

According to exemplary embodiments, communications unit 116 may include one or more receivers, transmitters, and/or transceivers. Communications unit 116 may be configured to send/receive a transmission protocol, such as BLUETOOTH®, ZIGBEE®, Wi-Fi, induction wireless data transmission, radio frequencies, radio transmission, radio-frequency identification (“RFID”), near-field communication (“NFC”), infrared, network interfaces, cellular technologies such as 3G (3GPP/3GPP2), high-speed downlink packet access (“HSDPA”), high-speed uplink packet access (“HSUPA”), time division multiple access (“TDMA”), code division multiple access (“CDMA”) (e.g., IS-95A, wideband code division multiple access (“WCDMA”), etc.), frequency-hopping spread spectrum (“FHSS”), direct sequence spread spectrum (“DSSS”), global system for mobile communication (“GSM”), Personal Area Network (“PAN”) (e.g., PAN/802.15), worldwide interoperability for microwave access (“WiMAX”), 802.20, long term evolution (“LTE”) (e.g., LTE/LTE-A), time division LTE (“TD-LTE”), global system for mobile communication (“GSM”), narrowband/frequency-division multiple access (“FDMA”), orthogonal frequency-division multiplexing (“OFDM”), analog cellular, cellular digital packet data (“CDPD”), satellite systems, millimeter wave or microwave systems, acoustic, infrared (e.g., infrared data association (“IrDA”)), and/or any other form of wireless data transmission.

Communications unit 116 may also be configured to send/receive signals utilizing a transmission protocol over wired connections, such as any cable that has a signal line and ground. For example, such cables may include Ethernet cables, coaxial cables, Universal Serial Bus (“USB”), FireWire, and/or any connection known in the art. Such protocols may be used by communications unit 116 to communicate to external systems, such as computers, smart phones, tablets, data capture systems, mobile telecommunications networks, clouds, servers, or the like. Communications unit 116 may be configured to send and receive signals comprising numbers, letters, alphanumeric characters, and/or symbols. In some cases, signals may be encrypted, using algorithms such as 128-bit or 256-bit keys and/or other encryption algorithms complying with standards such as the Advanced Encryption Standard (“AES”), RSA, Data Encryption Standard (“DES”), Triple DES, and the like. Communications unit 116 may be configured to send and receive statuses, commands, and other data/information. For example, communications unit 116 may communicate with a user operator to allow the user to control robot 102. Communications unit 116 may communicate with a server/network (e.g., a network) in order to allow robot 102 to send data, statuses, commands, and other communications to the server. The server may also be communicatively coupled to computer(s) and/or device(s) that may be used to monitor and/or control robot 102 remotely. Communications unit 116 may also receive updates (e.g., firmware or data updates), data, statuses, commands, and other communications from a server for robot 102.

In exemplary embodiments, operating system 110 may be configured to manage memory 120, controller 118, power supply 122, modules in operative units 104, and/or any software, hardware, and/or features of robot 102. For example, and without limitation, operating system 110 may include device drivers to manage hardware recourses for robot 102.

In exemplary embodiments, power supply 122 may include one or more batteries, including, without limitation, lithium, lithium ion, nickel-cadmium, nickel-metal hydride, nickel-hydrogen, carbon-zinc, silver-oxide, zinc-carbon, zinc-air, mercury oxide, alkaline, or any other type of battery known in the art. Certain batteries may be rechargeable, such as wirelessly (e.g., by resonant circuit and/or a resonant tank circuit) and/or plugging into an external power source. Power supply 122 may also be any supplier of energy, including wall sockets and electronic devices that convert solar, wind, water, nuclear, hydrogen, gasoline, natural gas, fossil fuels, mechanical energy, steam, and/or any power source into electricity.

One or more of the units described with respect to FIG. 1A (including memory 120, controller 118, sensor units 114, user interface unit 112, actuator unit 108, communications unit 116, mapping and localization unit 126, and/or other units) may be integrated onto robot 102, such as in an integrated system. However, according to some exemplary embodiments, one or more of these units may be part of an attachable module. This module may be attached to an existing apparatus to automate so that it behaves as a robot or provide additional capabilities to an existing robot. Accordingly, the features described in this disclosure with reference to robot 102 may be instantiated in a module that may be attached to an existing apparatus and/or integrated onto robot 102 in an integrated system. Moreover, in some cases, a person having ordinary skill in the art would appreciate from the contents of this disclosure that at least a portion of the features described in this disclosure may also be run remotely, such as in a cloud, network, and/or server.

As used herein, a robot 102, a controller 118, or any other controller, processor, or robot performing a task, operation or transformation illustrated in the figures below comprises a controller executing computer readable instructions stored on a non-transitory computer readable storage apparatus, such as memory 120, as would be appreciated by one skilled in the art.

Next referring to FIG. 1B, the architecture of a processor or processing device 138 is illustrated according to an exemplary embodiment. As illustrated in FIG. 1B, the processor 138 includes a data bus 128, a receiver 126, a transmitter 134, at least one processor 130, and a memory 132. The receiver 126, the processor 130 and the transmitter 134 all communicate with each other via the data bus 128. The processor 130 is configurable to access the memory 132 which stores computer code or computer readable instructions in order for the processor 130 to execute the specialized algorithms. As illustrated in FIG. 1B, memory 132 may comprise some, none, different, or all of the features of memory 120 previously illustrated in FIG. 1A. The algorithms executed by the processor 130 are discussed in further detail below. The receiver 126 as shown in FIG. 1B is configurable to receive input signals 124. The input signals 124 may comprise signals from a plurality of operative units 104 illustrated in FIG. 1A including, but not limited to, sensor data from sensor units 114, user inputs, motor feedback, external communication signals (e.g., from a remote server), and/or any other signal from an operative unit 104 requiring further processing. The receiver 126 communicates these received signals to the processor 130 via the data bus 128. As one skilled in the art would appreciate, the data bus 128 is the means of communication between the different components—receiver, processor, and transmitter—in the processing device. The processor 130 executes the algorithms, as discussed below, by accessing specialized computer-readable instructions from the memory 132. Further detailed description as to the processor 130 executing the specialized algorithms in receiving, processing and transmitting of these signals is discussed above with respect to FIG. 1A. The memory 132 is a storage medium for storing computer code or instructions. The storage medium may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage medium may include volatile, nonvolatile, dynamic, static, read/write, read-only, random-access, sequential-access, location-addressable, file-addressable, and/or content-addressable devices. The processor 130 may communicate output signals to transmitter 134 via data bus 128 as illustrated. The transmitter 134 may be configurable to further communicate the output signals to a plurality of operative units 104 illustrated by signal output 136.

One of ordinary skill in the art would appreciate that the architecture illustrated in FIG. 1B may also illustrate an external server architecture configurable to effectuate the control of a robotic apparatus from a remote location. That is, the server may also include a data bus, a receiver, a transmitter, a processor, and a memory that stores specialized computer readable instructions thereon.

One of ordinary skill in the art would appreciate that a controller 118 of a robot 102 may include one or more processors 138 and may further include other peripheral devices used for processing information, such as ASICS, DPS, proportional-integral-derivative (“PID”) controllers, hardware accelerators (e.g., encryption/decryption hardware), and/or other peripherals (e.g., analog to digital converters) described above in FIG. 1A. The other peripheral devices when instantiated in hardware are commonly used within the art to accelerate specific tasks (e.g., multiplication, encryption, etc.) which may alternatively be performed using the system architecture of FIG. 1B. In some instances, peripheral devices are used as a means for intercommunication between the controller 118 and operative units 104 (e.g., digital to analog converters and/or amplifiers for producing actuator signals). Accordingly, as used herein, the controller 118 executing computer readable instructions to perform a function may include one or more processors 138 thereof executing computer readable instructions and, in some instances, the use of any hardware peripherals known within the art. Controller 118 may be illustrative of various processors 138 and peripherals integrated into a single circuit die or distributed to various locations of the robot 102 which receive, process, and output information to/from operative units 104 of the robot 102 to effectuate control of the robot 102 in accordance with instructions stored in a memory 120, 132. For example, controller 118 may include a plurality of processors 138 for performing high level tasks (e.g., planning a route to avoid obstacles) and processors 138 for performing low-level tasks (e.g., producing actuator signals in accordance with the route).

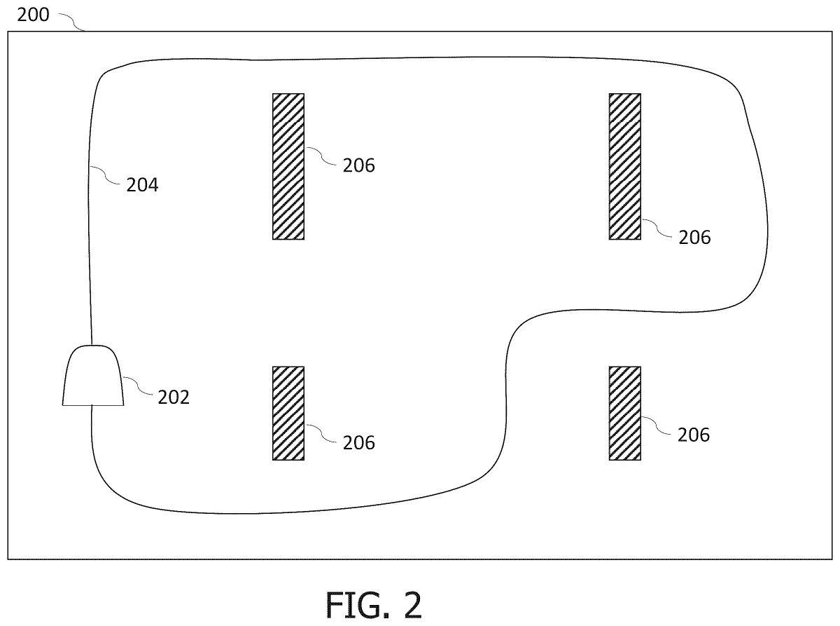

FIG. 2 illustrates a computer readable map 200 comprising a robot footprint 202, a route 204, and a plurality of objects 206, according to an exemplary embodiment. The footprint 202 may correspond to an area occupied by a robot 102 as viewed from above the plane of the map 200. The plane of the map 200 comprises the horizontal plane. That is, the map 200 is a top-down view of the environment and the footprint 202 corresponds to an area occupied by the robot 102 as viewed from the top-down. The route 202 may correspond to a path for the robot 102 to follow, wherein the route 202 may be demonstrated to the robot 102, downloaded from a file or server, and/or otherwise recalled from memory 120 of the robot 102. The computer readable map 200 may include a plurality of pixels, each pixel corresponding to an area within the environment of the robot 102. For example, each pixel of the map 200 may correspond to a 3×3 cm area (viewed from the top-down). One skilled in the art may recognize that pixels of the map 200 may represent other area sizes, such as 1×1 cm, 10×10 cm, etc. In some embodiments, the areas represented by each pixel may be rectangles, such as 3×2 cm, 5×2 cm, etc. areas. A controller 118 of the robot 102 may check if the robot 102 is colliding or would collide with an object 306 based on an overlap between footprint 202 and an object 306. That is, a collision occurs when a pixel of the map 200 includes both the robot footprint 202 and an object 206. A near-collision, as used herein, occurs when the pixel separation between the robot footprint 202 and an object 206 is less than a threshold number, wherein a controller 118 of the robot 102 may stop the robot 102 if a near-collision occurs.

According to at least one non-limiting exemplary embodiment, the map 200 may be illustrative of a cost map. A cost map, as used herein, includes a plurality of pixels, each pixel comprises an associated cost. The cost corresponds to a numerical value assigned to each pixel of the map 200 based on the pixel representing the route 204, object 206, or empty space (white area). Costs for pixels representing objects 206 may be substantially high to deter the robot 102 from navigating over or near an object 206. Conversely the cost for navigating along route 204 pixels may be low or negative (i.e., a reward). For example, a robot 102 navigating out in the open, such as illustrated in FIG. 2, may incur low costs as the footprint 202 is not overlapping any objects. Conversely, if the footprint 202 overlaps with a pixel representing an object 206, the cost may drastically increase. To execute a route 304, the controller 118 may calculate costs for navigating each portion of the route 204 and/or costs for deviating from the route 204 (e.g., to avoid an object) and execute a path corresponding to a lowest total cost.

According to at least one non-limiting exemplary embodiment, robot 102 may include one or more actuated features which extend, retract, or otherwise change the shape or size of the robot 102. Footprint 202 may change over time based on the controller 118 of the robot 102 changing the size or shape of the robot 102 via the one or more actuated features.

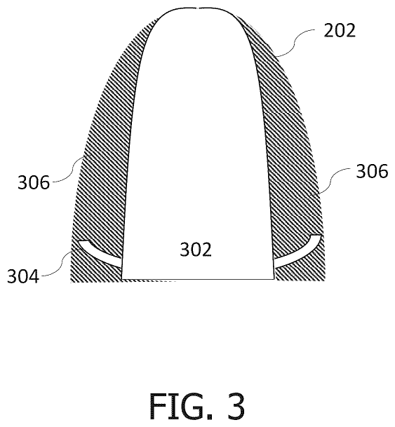

FIG. 3 illustrates a robot footprint 202 superimposed over a robot body form 302, according to an exemplary embodiment. The body form 302 is illustrative of a true shape of the robot 102, as viewed from the top-down. For example, robot 102 may include a floor scrubber robot comprising protruding members 304 representing a squeegee, a scrubber, or a similar component, which drags along a floor behind the scrubber robot. It may be difficult and/or computationally costly for a controller 118 to perfectly represent the body form 302 on computer readable maps and thus may utilize an approximate footprint 202 as shown. Further, it may be desirable to provide a footprint 202 with an enlarged area to provide a safety margin for when the robot is traveling at relatively high speeds.

The shaded areas represent blind spots 306. The blind spots 306 correspond to regions where a controller 118 digitally determines the robot 102 to exist, but, as shown by body form 302, the robot 102 does not exist. That is, blind spots 306 correspond to regions included within a digital footprint 202, which do not include portions of the physical body form 302 of the robot 102. In some instances, the controller 118 of the robot 102 may determine the robot 102 is colliding with an object 206 on a map based on an overlap between footprint 202 and the object 206, when in actuality, the robot 102 is only in collision with the object 206 when body form 302 overlaps with the object. For example, if controller 118 configures footprint 202 to include no blind spots 306 such that footprint 202 and body form 302 are substantially similar, any imperfection in localization may cause a portion of the robot body 302 to be misaligned with the footprint 202 on the map which may pose a risk for collision due to imperfect representation of the robot 102 on the map. Footprints 202 are typically configured to overestimate the size of the robot 102 to account for imperfect localizations as well as other noise and perturbations as a safety precaution. Accordingly, if a pixel of an object 306 intersects with or comes within a threshold distance to footprint 202, the controller 118 of the robot 102 may stop the robot 102 due to a perceived collision when the robot 102 may have enough room to navigate away from the object 306 without the body form 302 colliding with object 306. Accordingly, the systems and methods discussed below will enable a robot 102 to estimate and simplify its footprint 202 to improve or maintain motion calculation speeds while enabling the robots 102 to execute maneuvers safely despite maps otherwise indicating the robot 102 is in collision.

One skilled in the art may appreciate that a body form 302 of a robot 102 may include a plurality of portions which do not perfectly conform to the shape of footprint 202, wherein the body form 302 and footprint 202 are simplified for clarity of illustration.

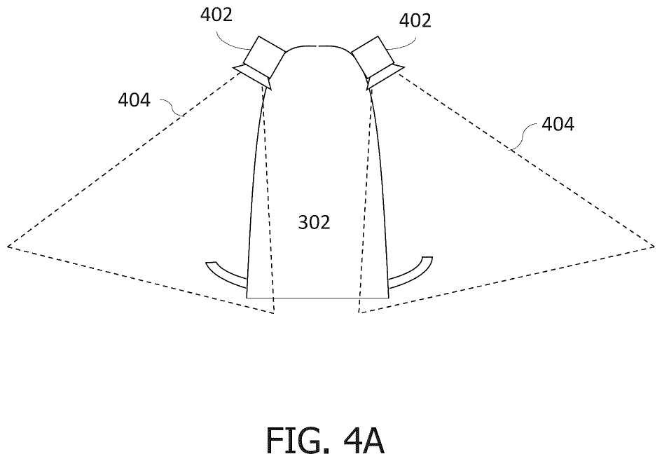

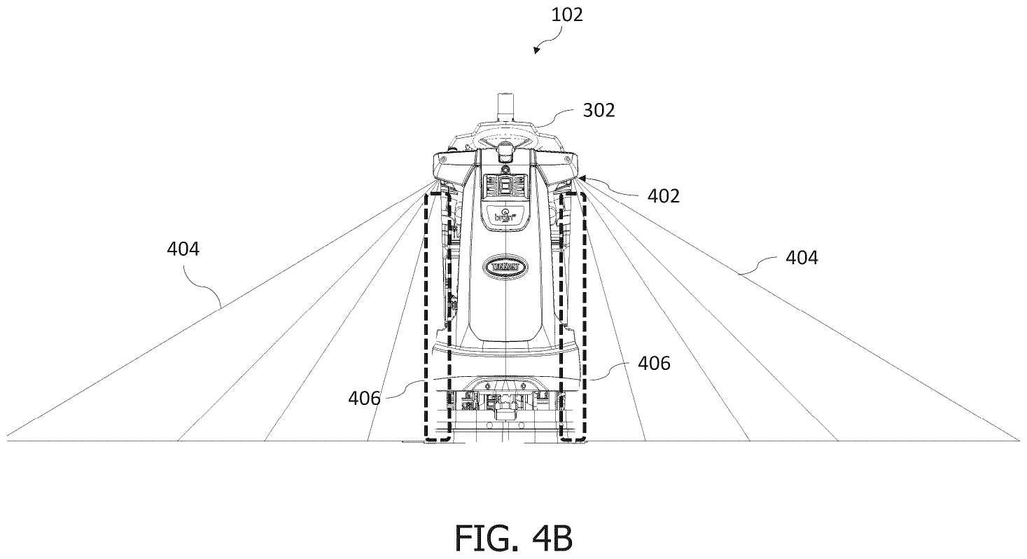

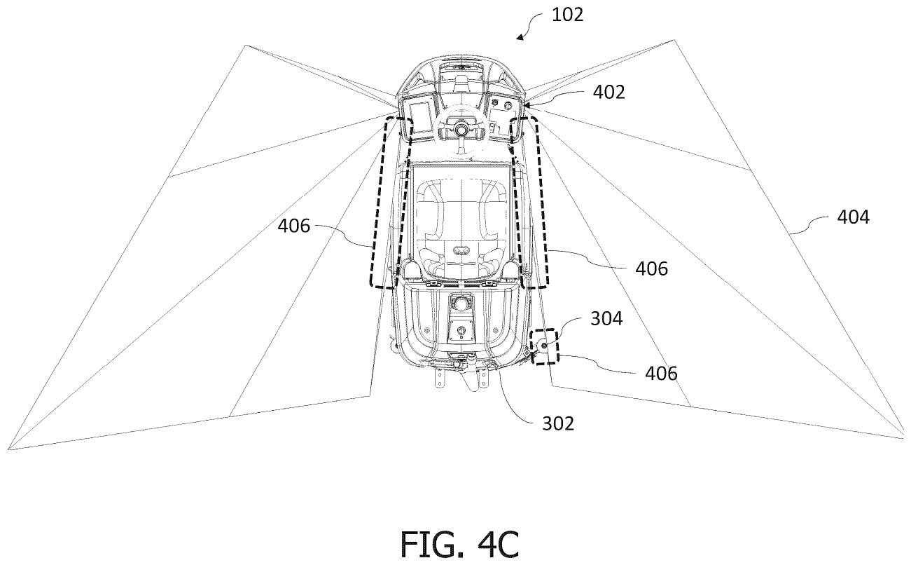

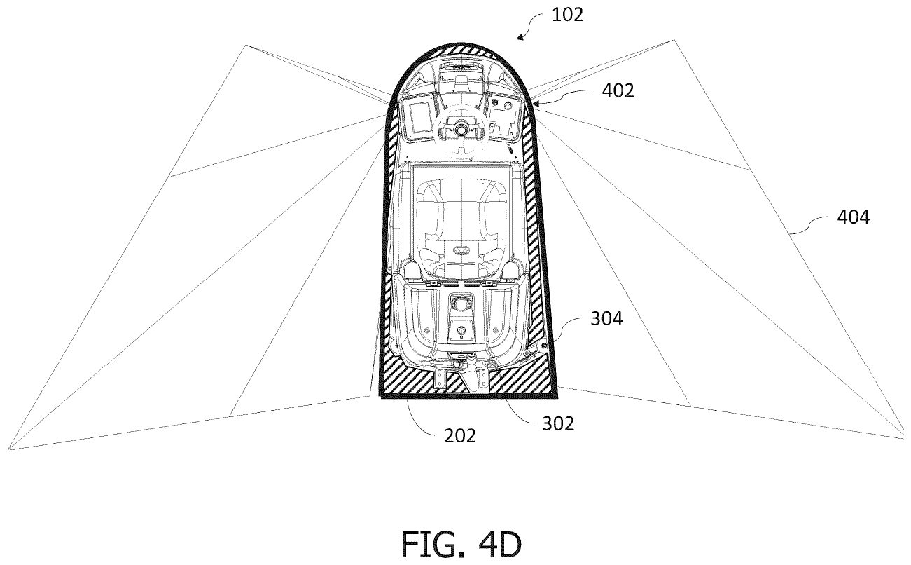

FIG. 4A illustrates a configuration of two depth camera sensors 402 on a robot 102, according to an exemplary embodiment. In some configurations, such as the one illustrated, both depth camera sensors 402 may include a field of view, shown by fields of view 404, which encompass a portion of the robot 102 body form 302 such that images depict a portion of the robot body. Depth information from the depth camera sensors 402 may also contain distance measurements between the sensors 402 and the robot body 302.

One skilled in the art may appreciate other configurations of one or more depth cameras 402 which sense at least a portion of the robot body 302. For example, the depth cameras 402 may be disposed near the rear at the side of the robot 102 and sense a frontward side of the robot 102. As another example, a depth camera 402 may be positioned in the front or rear of the robot 102 and sense the front and rear sides of the robot 102. Although one specific configuration is illustrated in FIG. 4A-C, the systems and methods of this disclosure are applicable to any configuration of depth cameras 402 which sense a portion of the robot body 302.

FIG. 4B illustrates a computer aided design (“CAD”) rendering of a robot 102 from a front-facing view, the robot 102 comprises two depth cameras 402, according to an exemplary embodiment. In this embodiment, the robot 102 is a floor cleaning robot, but one skilled in the art may appreciate that the present disclosure is applicable to any robot with any functionality. As shown, robot 102 includes two depth cameras 402 configured such that their respective fields of view 404 sense areas surrounding the robot 102 and a portion of the robot 102 body 302. The fields of view 404 sense portions 406 of the robot 102 body form 302. Next, FIG. 4C illustrates the same robot shown in FIG. 4B from a top-down view, according to the exemplary embodiment. Regions 406 correspond to regions of field of view 404 which detect a portion of the robot 102 body form 302. In the illustrated embodiment, the two depth cameras 402 detect the frontward sides and a protruding feature 304, such as a squeegee used to clean floors.

Next, in FIG. 4D, a robot footprint 202 is superimposed over the robot body form 302, according to the exemplary embodiment previously described in FIG. 4B-C. Robot footprint 202 corresponds to the size and shape of the robot 102 as perceived by its controller 118 on computer readable maps (e.g., 200). As mentioned previously, perfectly representing the outline of the robot body 302 may be computationally taxing when the controller 118 is planning motions of the robot 102 using a computer readable map if the contour of the footprint 202 is a complex shape. Further, using a perfectly accurate footprint 202 which includes the same shape as body 302 may cause portions of the body 302 to not align with the footprint 202 on the computer readable map if localization of the robot 102 is not perfect. Accordingly, footprint 202 may be an over approximation of the size and shape of the robot body 302. Typically, footprints 202 are over-approximated to provide a margin for safety around the robot 102 and/or to account for imperfect localization. Further, if a portion of the robot body 302 (e.g. 304), protrudes from the footprint 202, the portion may collide with an object despite the computer readable map not indicating any collision. Due to this over-approximation of footprint 202 with respect to the true robot body 302 shape/size, blind spots are created. Blind spots correspond to the hashed regions within footprint 202 where no portion of the robot body 302 exists. These blind spots, if an object is present therein, may cause the robot 102 to stop, as controller 118 detects a collision due to footprint 202 overlapping with an object on the computer readable map, when in actuality the object is not in collision with the robot body 302.

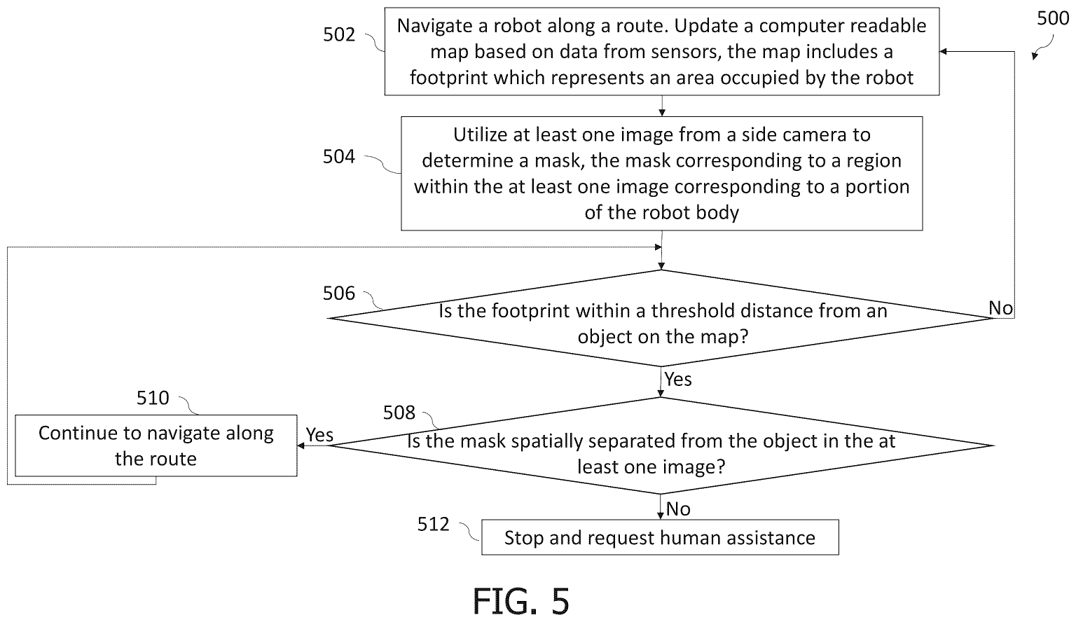

FIG. 5 is a process flow diagram illustrating a method 500 for a controller 118 of a robot 102 to enhance navigation using a dynamic mask for depth imagery, according to an exemplary embodiment. The robot 102 may include one or more exteroceptive sensor units 114 detecting a portion of the robot body 302, such as the surface of a wheel, chassis, rear, front, and/or other sides of the robot 102. The exteroceptive sensors may include, for example, distance measuring sensors (e.g., depth cameras 402), image cameras, or LiDAR sensors. One skilled in the art would appreciate that steps of method 500 are effectuated by the controller 118 executing computer readable instructions from memory 120.

Block 502 includes the controller 118 navigating the robot 102 along a route and updating a computer readable map (e.g., 200) used to navigate the robot 102 based on data collected by sensor units 114. Navigating the robot 102 may include following a path (e.g., 204), but may further include the controller 118 generating a path by exploring the environment (e.g., a random walk), navigating within an enclosed area (e.g., an area fill pattern), and/or moving from one location to another. Navigating the robot 102 may further include the controller 118 executing one or more motion commands which cause the robot 102 to move. The computer readable map may include a plurality of localized objects using data from sensor units 114. The computer readable map may further include a footprint 202 of the robot 102, as described in FIG. 2-3 above. Updates to the computer readable map may include updating the location of the footprint 202 based on motion of the robot 102, detecting and mapping any objects, and/or updating the locations of the objects if the object move.

Block 504 includes the controller 118 utilizing at least one image from a sensor to determine a mask, wherein the mask corresponds to pixels within the at least one image which depict and/or measure the robot 102. In some embodiments, controller 118 may utilize n most recent images to determine the pixels of the n images which depict the robot 102, n being an integer number greater than zero.

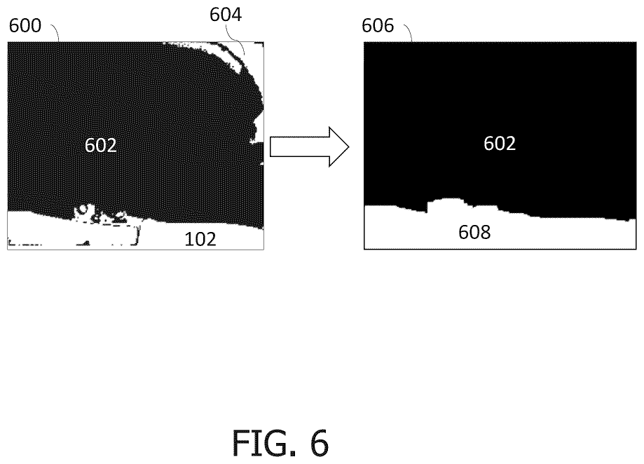

For example, FIG. 6 illustrates an image 600 captured by the sensor of the robot 102, the image depicting a floor 602 (black) and portion of the robot 102 body (white). Image 600 may correspond to a depth image captured by depth cameras 402 shown in FIG. 4A-C above. Pixels 604 may comprise pixels depicting a bright spot on floor 602, such as if floor 602 is glossy and beneath bright overhead lights, or noise pixels in depth imagery. In depth imagery, noise pixels 604 may be caused by excess illumination, such as lights shining on a glossy floor. Noise may further increase as distance between the depth camera 402 and target object (i.e., floor 602) increases. Noise is typically detected based on saturation of a CCD (e.g., due to excessive lighting conditions) and/or where pixels 604 include no distance measurements to be produced for pixels 604 due to excessive lighting conditions (drowned out signal) and/or reflections away from the camera. Noise 604 may be filtered from the output image 606. The controller 118 may determine the position of the sensor (e.g., based on distance measurements or pose values stored in memory 120) such that the region which depicts the robot 102 may be quickly and readily estimated. Controller 118 may calculate an image mask 608 comprising a plurality of pixels of the image 600 which depict the robot 102. The mask 608 is shown on image 606. The mask 608 size and location (i.e., pixels encompassed by the mask 608) may be stored in memory 120 and/or updated as the controller 118 receives additional images.

According to at least one non-limiting exemplary embodiment, controller 118 may utilize pixel wise disparity measurements between two or more images captured sequentially or non-sequentially to determine pixels of the two images which depict the robot 102. As the robot 102 navigates its surroundings, regions of collected images which include the robot 102 may not change substantially, wherein pixels which change substantially may correspond to pixels which do not depict the robot 102. Motion analysis between two or more successive images while the robot 102 is in motion may be utilized by the controller 118 to determine mask 608 as the robot 102 body does not move substantially between successive images while a background will.

According to at least one non-limiting exemplary embodiment, controller 118 may determine pixels of the image 600 which depict the robot 102 based on the color values of the pixels. Memory 120 may include an expected color of the robot 102, for example, if the robot 102 is orange, controller 118 may expect that orange pixels correspond to the robot 102. Some tolerance may be included to account for dynamic lighting conditions of an environment. For example, controller 118 may expect pixels depicting the robot 102 may include RGB values of (200, 50, 0) but, due to dynamic lighting conditions, the RGB color values of pixels of image 600 may deviate from the ideal color by 5%, 10%, 20%, etc.

According to at least one non-limiting exemplary embodiment, the sensors used in block 504 may include depth camera sensors. Controller 118 may further utilize depth data (i.e., point cloud data) to determine locations within the depth data and images which correspond to the robot 102 body. As mentioned above, depth images correspond to images (e.g., RGB, greyscale, etc.) which are each further encoded with a distance measurement, the distance measurement being a distance between the depth camera and an object depicted by a pixel of the depth image, wherein the distance measurement is typically measured using a time of flight of electromagnetic energy. For example, distance measurements between the depth camera and portions of the robot body 302 seen in its field of view may rarely change whereas distance measurements which sense regions external to the robot body 302 may change drastically based on the presence, or lack thereof, of objects within these regions. Thus a persistent region, or region comprising pixels which include little change of color/distance measurement over time, may correspond to the portion 608 depicting the robot body.

According to at least one non-limiting exemplary embodiment, a convex hull, or convex shape which encloses an area, which encloses the plurality of pixels which depict the robot body 302 may be utilized to produce mask 608. The convex hull may overestimate the size of the robot body 302, however typically the overestimation is substantially less than the overestimation between a footprint 202 and the body 302 (e.g., as shown in FIG. 4C). The convex hull may be defined based on a plurality of single pixel points connected by lines, the plurality of points represents points of the robot body depicted in image 600. Such points may be detected using edge detection, image segmentation, pattern recognition (e.g., using one or more filters), analysis of distance measurements, color values, and the like. By connecting the plurality of points which lie on the robot body, a convex hull (region 608) may be produced which encompasses the entire robot body as depicted in image 600. Each point may form a vertex comprising an angle of less than 180 degrees.

Returning to FIG. 5, block 506 includes the controller 118 determining if the footprint 202 of the robot 102 is within a threshold distance from an object on the map, indicating a collision or near collision between the robot 102 and the object localized on the map. As discussed in FIG. 3-4 above, the footprint 202 on the map may overestimate the size/shape of the robot 102. The controller 118 may utilize an overestimated footprint 202 for safety and/or performance. For example, it may be advantageous for a robot 102 to perceive itself as bigger than it truly is to avoid collisions due to sensor noise and/or errors. Further, use of an overestimated and simple footprint shape may improve the speed at which controller 118 calculates motion commands for the robot 102 (i.e., reduces the cycle time of motion planning decisions). The overestimated footprint may include at least the aforementioned benefits, however typically the controller 118 may assume the robot 102 is in collision with an object based on the footprint 202 and a map when the object is not in contact with the robot 102. The threshold distance may comprise zero-pixel or greater separation between the footprint 202 and the map (i.e., the footprint 202 overlaps with an object) based on the size of the robot, speed, spatial resolution of the map, noise of sensor units 114, safety margins, and the like. The distance between the robot 102 and the object may be calculated using the closest point/pixel of the robot footprint 202 to the object.

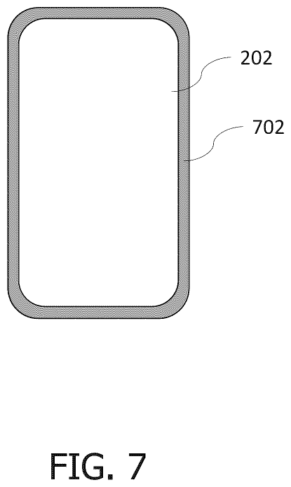

According to at least one non-limiting exemplary embodiment, controller 118 may impose a buffer zone 702 surrounding the footprint as shown in FIG. 7 to determine if the robot is within the threshold distance from the object on the map. The buffer zone 702 may comprise an n pixel buffer surrounding the footprint 202 on the computer readable map, n being a positive integer number. Controller 118 may determine if the footprint 202 is within a threshold distance from an object upon the object overlapping with the buffer zone 702 on the computer readable map. In some embodiments, the size of the buffer zone 702 may increase as the speed of the robot 102 increases to enable the robot 102 to fully stop upon navigating close to an object. Stated differently, the buffer zone 702 imposes a region within which, if any objects are detected, the controller 118 switches from using a footprint 202 to navigate to using visual distance discussed next in block 508.

Upon the controller 118 determining the robot footprint 202 is within a threshold distance from an object on the map (e.g., based on the object being within a buffer zone 702), the controller 118 moves to block 508.

Upon the controller 118 determining the robot footprint 202 is not within a threshold distance from with any object on the map, the controller 118 returns to block 502.

Block 508 includes the controller 118 determining if the mask 608 is spatially separated from any objects within the at least one image. Controller 118 may detect within the images a floor and a portion of the robot 102 body (i.e., the mask). In some embodiments, controller 118 may further receive distance measurements (i.e., depth images). Controller 118 may utilize either visual analysis, e.g., determining the mask 608 is spatially separated from any objects by one or more pixels, and/or analysis on depth measurements, e.g., determining the mask 608 (and distance measurements thereof) is spatially separated from any objects by a threshold distance, to determine if the robot 102 is truly in collision or substantially near collision with an object. That is, mask 608 denotes the true position of robot body 302, including any features (e.g., 304) which are not included in footprint 202, and is used by the controller 118 to measure the true distance between the robot 102 and the object. Steps in blocks 504-510 are analogous to steps taken by a human parking a car in a tight space, where the human may drive close to two neighboring cars (using an approximate mental footprint of their car) and, upon their car being within a threshold (close) distance to the neighboring ones, visually inspect the side clearance between their car and the two neighboring ones (analogous to the use of the mask), e.g., by looking out the windows/mirrors. The spatial separation between the mask 608 and the object may be calculated using a point/pixel of the mask 608 which is closest to the object. Use of depth cameras is not required, however, depth information from such depth cameras may yield more precise distances between the mask 608 (more importantly, the portion of the mask 608 closest to an object) and an object.

Upon controller 118 determining the robot 102 body is in collision with or the mask 608 is within a threshold distance from an object, the controller 118 moves to block 512 and stops navigating along the route. The robot 102 may also request human assistance as continuing to navigate substantially close to the object may pose a risk of damage to the robot 102 and the object.

Upon controller 118 determining the robot 102 body is not in collision with or within a threshold distance from an object, the controller 118 moves to block 510.

Block 510 includes the controller 118 continuing to navigate the robot 102 using the image mask 608 to calculate its distance to the object. Controller 118 may continue navigating the robot 102 at a slower speed for a period of time as a safety precaution due to its close proximity to the object.

Block 512 includes the controller 118 stopping the robot 102 and requesting human assistance. The controller 118 may utilize communications units 116 to emit a signal to a human, such an audio (e.g., beep) or visual signal (e.g., flashing light), or to a device of the human, such as a cell phone, a server, a personal computer, etc. The signal comprises the request for the human to aid the robot 102. In some embodiments, robot 102 may be equipped with rear-facing sensors to enable the robot 102 to safely reverse its motions and attempt to navigate the route again, however one skilled in the art may appreciate that robots 102, especially non-holonomic robots 102, may not always be able to recover or reverse out of its situation without a high risk of collision, wherein it may be preferable for a human to resolve the situation by manually moving or assisting the robot 102.

Blocks 506-510 represent a cycle wherein the controller 118, upon the robot 102 navigating within a first threshold (block 506) distance to an object (e.g., denoted by a buffer zone 702), switches from using the footprint 202 to estimate the size/shape of the robot 102 to using the image mask 608 (block 508) to estimate the size/shape of the robot 102. Due to the image mask 608 more accurately representing the true body form 302 of the robot 102 as compared to the footprint 202, the controller 118 may more accurately calculate the actual distance between the robot 102 and the object to determine if the robot 102 can continue navigating despite the footprint 202 and computer readable map indicating the robot is in collision. Once the robot 102 has moved beyond the object such that the footprint 202 no longer overlaps with or is within a threshold distance from the object, the controller 118 returns to block 502 and continues to use the footprint 202 to plan the motions of the robot 102. That is, the first threshold (block 506) causes the controller 118 to switch from navigating using the footprint 202 to estimate the distance to the object to using the mask 608 to estimate the distance to the object.

Advantageously, method 500 enables the controller 118 to utilize under-estimated and simplified footprints 202 while the robot 102 is far away from objects which improves the speed at which the controller 118 may calculate motions of the robot 102 while enabling the controller 118 to, upon navigating close to an object, accurately determine its distance to the object. In some embodiments, robots 102 may learn a route via user demonstration, wherein the user may push, drive, pull, or otherwise move the robot 102 through the route. The human user may visually check if the robot 102 has clearance to navigate nearby objects when demonstrating the route, however the human often is unaware of the overestimation of the robot footprint 202, thereby causing some maneuvers demonstrated by the human to be unreproducible by the robot 102. Method 500 enables the controller 118 of the robot 102 to visually inspect its clearance from an object, similar to how the human demonstrated the route, enabling the robot 102 to learn more complex routes from humans.

It is appreciated that method 600 may be executed multiple times until either (i) the robot 102 moves a substantial distance away from the object, causing the determination in block 506 to be “no” which, in turn, causes the controller 118 to no longer utilize the mask 608 to calculate distance between the robot 102 and the object; or (ii) the robot 102 collides or nearly collides with the object, causing the controller 118 to stop the robot 102 and request human assistance (block 510).

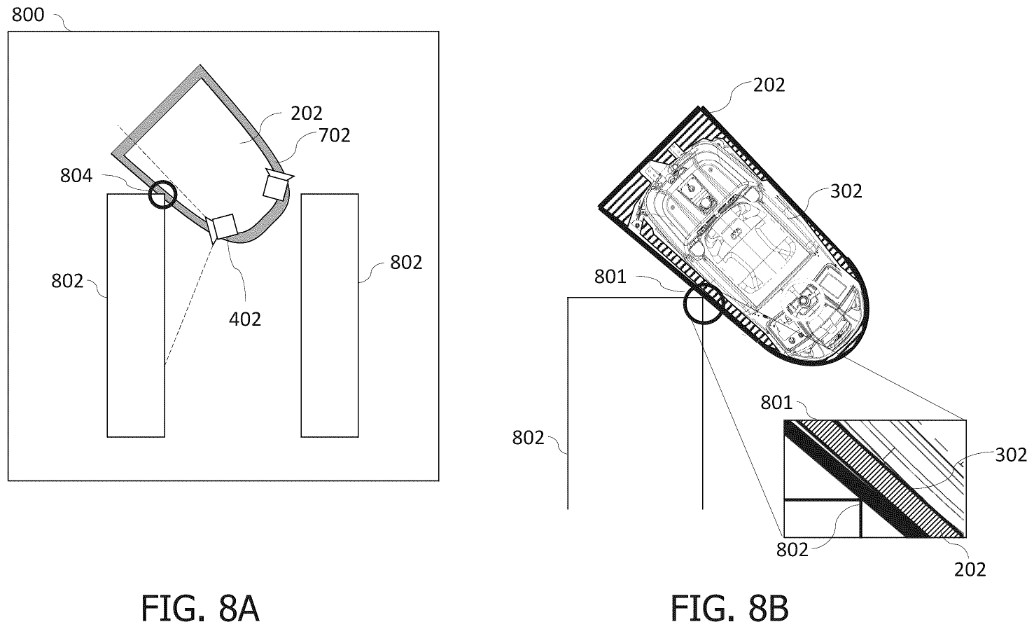

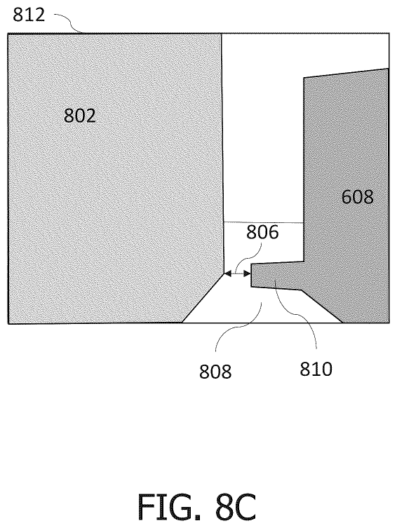

FIG. 8A illustrates a computer readable map 800 including a robot 102, represented by a footprint 202, navigating between two objects 802, according to an exemplary embodiment. The robot 102 may include sensors 402 as shown in FIG. 4 above. The robot 102 may follow a tight turn into a narrow passageway between the objects 812. Tight turns into narrow passageways are often difficult maneuvers for autonomous robots 102, requiring precise localization and navigation. As the robot 102 turns into the passageway, the map 800 may indicate the robot 102 is within a threshold distance to the left object 802, based on a pixel of the object 802 being within a threshold distance from the footprint 202. This is shown by a pixel of the object 802 being within the buffer zone 702, shown within circle 804, which surrounds the footprint 202. Upon the object 802 being within a threshold distance to the robot footprint 202 (block 506), the controller 118 of the robot 102 may switch from using the footprint 202 to calculate the distance to the object 802 to using an image mask 608 to calculate the distance to the object 802.

As shown in FIGS. 3 and 4C above, the robot footprint 202 may overestimate the size and shape of the robot 102 as a safety precaution and to improve robot performance by reducing the cycle time of motion planning algorithms by simplifying the footprint 202. In some instances, the same or substantially similar footprint 202 may be utilized for various different makes/models of robot 102. The various makes/models of the robots 102 may comprise a similar body form, but not identical, which is encompassed within the footprint 202, leading to the footprint 202 overestimating the size/shape of the robots 102 differently depending on their make/model. Map 800 may also include a resolution based on the areas represented by the pixels of the map 800. For example, pixels of map 800 may illustrate 3×3 cm areas, wherein the resolution of the map is 3 cm. Accordingly, in some instances given the exemplary resolution, the robot 102 may be in collision based on map 800 while still remaining 5 cm away from the object 802. Further, sensory noise, calibration errors, and localization errors may further cause the footprint 202 to overlap with the object 802 on the map 800 while the robot 102, more specifically its body 302, is not in collision with the object 802.

FIG. 8B is atop-down view of a robot 102 navigating nearby the objects 802 shown on computer readable map 800 of FIG. 8A above, according to the exemplary embodiment. Illustrated for clarity is the body form 302 of the robot 102 superimposed on top of its footprint 202, previously shown on map 800. As shown, the footprint 202 is substantially close to or overlaps with the object 802, as indicated on the computer readable map 800. However, the robot body 302 does not touch the object 802. An expanded view 801 is shown which shows a close-up view of the distance between object 802, the footprint 202, and the robot body 302. As shown, the body 302 is not in collision with the object 802, however the footprint 202 is; thus the robot 102 may be able to continue the maneuver into the narrow passageway using its sensors 402.

FIG. 8C is an image 812 captured by a sensor 402 of the robot 102 shown in FIG. 8A, according to the exemplary embodiment. The controller 118 of the robot 102 may determine a mask 608, as described in FIG. 5-6, comprising a plurality of pixels which depict the robot body in the image 812. The mask 608 may be determined based on any method described herein, such as, for example, motion analysis between successive images captured by the sensor 202 (e.g., determining a moving background), utilizing depth information if sensor 402 is a depth camera, and/or image recognition (e.g., using pre-determined filters, color occurrence analysis, convolutional neural networks, etc.).

According to at least one non-limiting exemplary embodiment, image 812 shown may depict a point cloud if sensor 402 is a LiDAR sensor which does not produce images, such as scanning LiDARs. Controller 118 may determine the position of the sensor 402 on the robot 102 and the field of view of the sensor 402 such that the controller 118 may determine points of the point cloud which correspond to the robot 102 body.

As shown in image 812, robot 102 has clearance 806 to continue navigating into the narrow passageway. The object 802 of which the map 800 indicates robot 102 is in collision with a distance 806 away from the robot 102 (i.e., a distance 806 from the mask 608). Distance 806 may be measured in a number of pixels if image 812 is an image without depth measurements, or distance 806 may be measured based on distance measurements of the image 806 if image 806 is a depth image captured by a depth camera or LiDAR sensor. Accordingly, upon the controller 118 determining the distance 806 is at least a threshold magnitude, the controller 118 may continue navigating the robot 102 into the narrow passageway. In some instances, the controller 118 may limit the maximum speed of the robot 102 as it analyzes the images to determine distance 806 and ensure the robot 102 has sufficient clearance to continue navigating without collision. Upon returning to use of a footprint 202, the maximum speed may be increased to a normal value.

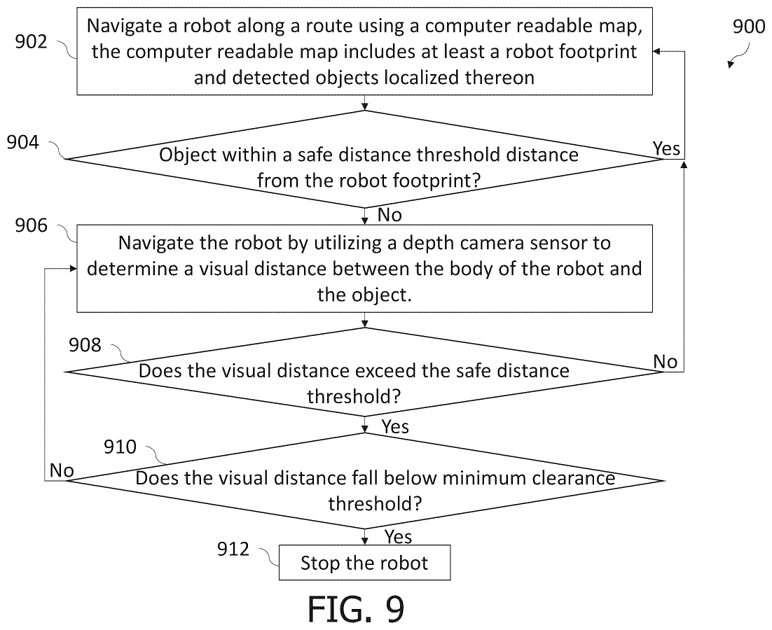

FIG. 9 is a process flow diagram illustrating a method 900 for a controller 118 of a robot 102 to navigate close to objects using visual perception, according to an exemplary embodiment. Steps of method 900 are effectuated via controller 118 executing computer readable instructions from memory 120, as appreciated by one skilled in the art.

Block 902 includes the controller 118 navigating a robot 102 along a route using a computer readable map. The computer readable map may include a plurality of objects detected and localized thereon based on data from one or more exteroceptive sensor units 114. The computer readable map may further include a robot footprint 202 which approximates the size, shape, and location of the robot 102 within its environment. The size and shape of the footprint 202 may be predetermined (e.g., predetermined during manufacturing or programming of the robot 102) and the position may be based on movements of the robot 102. The computer readable map may include a plurality of pixels, each pixel may represent an object (e.g., humans, shelves, walls, etc.), the robot footprint 202, and/or navigable space (e.g., clear floor space). In some embodiments, the computer readable map may include a route or path for the robot 102 to follow.

Block 904 includes the controller 118 determining if an object is within a safe distance threshold from the robot footprint 202 on the computer readable map. The safe distance threshold may correspond to a distance at which the robot 102 should stop if an object is within the safe distance threshold. The value (e.g., in meters) of the safe distance threshold may be configured based on a plurality of parameters of the robot 102 such as, without limitation, its maximum stopping distance, noise level of sensor units 114, resolution of the computer readable map, momentum of the robot 102 (e.g., some robots may comprise longer stopping distances with heavy payloads or objects attached thereto if the robot 102 is configured to transport objects), and/or in accordance with any relevant safety standards. For example, the safe distance threshold may be 10 cm, 20 cm, 30 cm, etc. which may translate to a number of pixels on the computer readable map. That is, the safe distance threshold may equate to the robotic footprint 202 being a threshold number of pixels from any objects on the computer readable map. In some embodiments, the safe distance threshold may correspond to a buffer region 702 as shown in FIG. 7, wherein any object being present within the buffer region may correspond to the object being within the safe distance threshold.

Upon the controller 118 determining one or more objects are within the safe distance threshold, controller 118 proceeds to block 906. Upon the controller 118 determining no objects are within the safe distance threshold, controller 118 returns to block 902.

Block 906 includes the controller 118 navigating the robot using a depth camera sensor to determine a visual distance between the body 302 of the robot 102 and the object. The depth camera includes a field of view which detects, at least in part, a portion of the robot body 302, as shown in FIG. 4A-C as an example. The visual distance may correspond to a spatial separation between the robot body 302 and the nearby object. The controller 118 may produce a mask comprising a plurality of pixels within depth imagery captured by the depth camera sensor which depict the portion of the robot body 302. Using this mask, the controller 118 may determine the spatial separation between the robot body 302 and the nearby object, as shown in FIG. 8 by distance 806. The controller 118 may further utilize depth measurements of the depth imagery to calculate the spatial separation more precisely between the robot body 302 (e.g., represented by mask 608 as shown and described above in FIGS. 6 and 8) and the nearby object. In some embodiments, block 906 may further include the controller 118 slowing the navigation speed of the robot 102.

It is appreciated that the visual distance comprises a more precise, robust, and accurate distance measurement between the robot body 302 and the object as compared to a distance calculated between the robot footprint 202 and the object using the computer readable map. Visual distance is less dependent on calibration of the depth camera as the exact position (i.e., (x, y, z, yaw, pitch roll)) of the depth camera 402 is not required to be known precisely in order to calculate the visual distance. Conversely, calculating distance using a computer readable map requires the controller 118 to precisely localize the robot 102 and nearby objects, which is dependent on precise calibration of exteroceptive sensor units 114. Further, precision of navigating the robot 102 using the computer readable map is limited to the resolution of the map (which is further limited by computational capacity of controller 118), whereas depth cameras typically include less than a centimeter spatial resolutions.

Block 908 includes the controller 118 determining if the visual distance measured using depth imagery exceeds the safe distance threshold. Accordingly, if the visual distance measured exceeds the safe distance threshold, the robot 102 has navigated sufficiently far away from the object for the object to no longer pose a risk for collision due to inaccuracies in navigating using only the computer readable map.

Upon controller 118 determining the visual distance exceeds the safe distance threshold, controller 118 returns to block 502.

Upon controller 118 determining the visual distance does not exceed the safe distance threshold, controller 118 moves to block 910.

Block 910 includes the controller 118 determining if the visual distance falls below a minimum clearance threshold. The minimum clearance threshold may correspond to the absolute minimum distance at which the robot 102 should navigate nearby any object. The minimum clearance threshold is smaller than the safe distance threshold. The minimum clearance threshold may be based on the precision of motion of the robot 102 (i.e., how precisely actuator units 108 may position the robot 102) and/or applicable safety standards or protocols. For example, a controller 118 may precisely position the robot 102 within a 2 cm resolution, wherein the minimum clearance threshold may be 2 cm or greater.

Upon the controller 118 determining the visual distance does not exceed the minimum clearance threshold, controller 118 returns to block 506 and continues navigating nearby the object using the visual distance to determine its clearance to the object.

Upon the controller 118 determining the visual distance falls below the minimum clearance threshold, controller 118 moves to block 512 to stop the robot. In some embodiments, the controller 118 may additionally call for user assistance via communications units 116 emitting an auditory noise, visual display (e.g., flashing light or display on a graphical user interface), and/or emitting a signal to a device (e.g., a cell phone of an operator of the robot 102) or a server. In some embodiments, robot 102 may be equipped with rear-facing sensors to enable the robot 102 to safely reverse its motions and attempt to navigate the route again, however one skilled in the art may appreciate that robots 102, especially non-holonomic robots 102, may not always be able to recover or reverse out of its situation without a high risk of collision, wherein it may be preferable for a human to resolve the situation by manually moving or assisting the robot 102.

In short, method 900 includes the controller 118 switching (block 904) from use of a computer readable map (block 902) to visual analysis (blocks 906-910) when navigating close to objects. Computer readable maps, as discussed above, include inaccuracies and limited precision, causing navigation close to objects to become difficult. Using visual analysis to sense the distance between a portion of the robot body and the nearby object may provide the controller 118 with a method for precisely determining clearance between the robot 102 and the object which is less reliant on calibration, includes greater precision, is of reasonable computational complexity, and is not limited to a resolution of the map but is limited to the resolution of the depth camera sensor. Typical depth cameras are precise to about 1-10 millimeters, whereas computer readable maps typically comprise 1-10 cm spatial resolutions, however these values are purely exemplary and non-limiting.

It will be recognized that while certain aspects of the disclosure are described in terms of a specific sequence of steps of a method, these descriptions are only illustrative of the broader methods of the disclosure, and may be modified as required by the particular application. Certain steps may be rendered unnecessary or optional under certain circumstances. Additionally, certain steps or functionality may be added to the disclosed embodiments, or the order of performance of two or more steps permuted. All such variations are considered to be encompassed within the disclosure disclosed and claimed herein.

While the above detailed description has shown, described, and pointed out novel features of the disclosure as applied to various exemplary embodiments, it will be understood that various omissions, substitutions, and changes in the form and details of the device or process illustrated may be made by those skilled in the art without departing from the disclosure. The foregoing description is of the best mode presently contemplated of carrying out the disclosure. This description is in no way meant to be limiting, but rather should be taken as illustrative of the general principles of the disclosure. The scope of the disclosure should be determined with reference to the claims.

While the disclosure has been illustrated and described in detail in the drawings and foregoing description, such illustration and description are to be considered illustrative or exemplary and not restrictive. The disclosure is not limited to the disclosed embodiments. Variations to the disclosed embodiments and/or implementations may be understood and effected by those skilled in the art in practicing the claimed disclosure, from a study of the drawings, the disclosure and the appended claims.

It should be noted that the use of particular terminology when describing certain features or aspects of the disclosure should not be taken to imply that the terminology is being re-defined herein to be restricted to include any specific characteristics of the features or aspects of the disclosure with which that terminology is associated. Terms and phrases used in this application, and variations thereof, especially in the appended claims, unless otherwise expressly stated, should be construed as open ended as opposed to limiting. As examples of the foregoing, the term “including” should be read to mean “including, without limitation,” “including but not limited to,” or the like; the term “comprising” as used herein is synonymous with “including,” “containing,” or “characterized by,” and is inclusive or open-ended and does not exclude additional, unrecited elements or method steps; the term “having” should be interpreted as “having at least;” the term “such as” should be interpreted as “such as, without limitation;” the term ‘includes” should be interpreted as “includes but is not limited to;” the term “example” or the abbreviation “e.g.” is used to provide exemplary instances of the item in discussion, not an exhaustive or limiting list thereof, and should be interpreted as “example, but without limitation;” the term “illustration” is used to provide illustrative instances of the item in discussion, not an exhaustive or limiting list thereof, and should be interpreted as “illustration, but without limitation.” Adjectives such as “known,” “normal,” “standard,” and terms of similar meaning should not be construed as limiting the item described to a given time period or to an item available as of a given time, but instead should be read to encompass known, normal, or standard technologies that may be available or known now or at any time in the future; and use of terms like “preferably,” “preferred,” “desired,” or “desirable,” and words of similar meaning should not be understood as implying that certain features are critical, essential, or even important to the structure or function of the present disclosure, but instead as merely intended to highlight alternative or additional features that may or may not be utilized in a particular embodiment. Likewise, a group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should be read as “and/or” unless expressly stated otherwise. The terms “about” or “approximate” and the like are synonymous and are used to indicate that the value modified by the term has an understood range associated with it, where the range may be ±20%, ±15%, ±10%, ±5%, or ±1%. The term “substantially” is used to indicate that a result (e.g., measurement value) is close to a targeted value, where close may mean, for example, the result is within 80% of the value, within 90% of the value, within 95% of the value, or within 99% of the value. Also, as used herein “defined” or “determined” may include “predefined” or “predetermined” and/or otherwise determined values, conditions, thresholds, measurements, and the like.

What is claimed is:

1. A method for maneuvering a robot, comprising:
navigating the robot using a computer readable map, the computer readable map comprising a footprint of the robot;
receiving sensor data from a sensor coupled to the robot, the sensor data comprises a field of view which encompasses at least a portion of a body of the robot;
detecting the footprint of the robot within a threshold distance to one or more objects localized on the computer readable map;
detecting a portion of the sensor data which senses the portion of the body of the robot within the field of view;
determining a distance between the body of the robot and the one or more objects based on the portions of the sensor data which senses the body of the robot and the one or more objects;
navigating the robot until the distance is below a threshold value; and
stopping the robot.

2. The method of claim 1, wherein,
the sensor comprises a depth camera;
the sensor data corresponds to depth imagery; and
the portion of the sensor data which senses the portion of the body of the robot corresponds to pixels of the depth imagery.

3. The method of claim 2, further comprising:
producing a pixel mask, the pixel mask corresponding to pixels of the depth imagery which depict the portion of the body of the robot within the field of view; and
updating the pixel mask based on the receipt of at least one additional depth image.

4. The method of claim 2, wherein,
the distance between the body of the robot and the one or more objects is measured based on depth values of the depth imagery.

5. The method of claim 3, wherein,
the portion of the body of the robot is detected within the depth imagery using at least one of: (i) motion analysis between two or more successive depth images, wherein the portion of the body of the robot is stationary; (ii) pixel color analysis between two or more depth images, wherein pixels comprising a large color differential between the two or more images are determined to not correspond to the robot; or (iii) expected distances between the depth camera and the robot based on calibration values for the depth camera.

6. The method of claim 1, further comprising
requesting human assistance using communications units coupled to the robot, the request for assistance comprising the robot to perform at least one of: (i) emitting an auditory noise; (ii) emitting a visual indication; or (iii) transmitting a signal using a cellular or Wi-Fi network to a device of a human.

7. A non-transitory computer readable storage medium comprising a plurality of computer readable instructions embodied thereon which, when executed by at least one controller, causes the at least one controller to:
navigate a robot using a computer readable map, the computer readable map comprising a footprint of the robot;
receive sensor data from a sensor coupled to the robot, the sensor data comprises a field of view which encompasses at least a portion of a body of the robot;
detect the robot footprint is within a threshold distance to one or more objects localized on the computer readable map;
detect a portion of the sensor data which senses the portion of the body of the robot within the field of view;
determine a distance between the body of the robot and the one or more objects based on the portions of the sensor data which senses the body of the robot body and the one or more objects;
navigate the robot until the distance is below a threshold value; and
stop the robot.

8. The non-transitory computer readable storage medium of claim 7, wherein,
the sensor comprises a depth camera;
the sensor data corresponds to depth imagery; and
the portion of the sensor data which senses the portion of the body of the robot corresponds to pixels of the depth imagery.

9. The non-transitory computer readable storage medium of claim 8, wherein the at least one controller is further configured to execute the computer readable instructions to:
produce a pixel mask, the pixel mask corresponding to pixels of the depth imagery which depict the portion of the body of the robot within the field of view; and
updating the pixel mask based on the receipt of at least one additional depth image.

10. The non-transitory computer readable storage medium of claim 8, wherein, the distance between the body of the robot and the one or more objects is measured based on depth values of the depth imagery.

11. The non-transitory computer readable storage medium of claim 9, wherein,
the portion of the body of the robot is detected within the depth imagery using at least one of: (i) motion analysis between two or more successive depth images, wherein the portion of the body of the robot is stationary; (ii) pixel color analysis between two or more depth images, wherein pixels comprising a large color differential between the two or more images are determined to not correspond to the robot; or (iii) expected distances between the depth camera and the robot based on calibration values for the depth camera.

12. The non-transitory computer readable storage medium of claim 7, wherein the at least one controller is further configured to execute the computer readable instructions to:
request human assistance using communications units coupled to the robot, the request for assistance comprising the robot to perform at least one of: (i) emitting an auditory noise; (ii) emitting a visual indication; or (iii) transmitting a signal using a cellular or Wi-Fi network to a device of a human.

13. A robotic system, comprising:
a memory comprising a plurality of computer readable instructions; and
at least one controller configured to execute the computer readable instructions to:
navigate the robotic system using a computer readable map, the computer readable map comprises a footprint of the robotic system;
receive sensor data from a sensor coupled to the robotic system, the sensor data comprises a field of view which encompasses at least a portion of a body of the robotic system;
detect the robotic system footprint within a threshold distance to one or more objects localized on the computer readable map;
detect a portion of the sensor data which senses the portion of the body of the robotic system within the field of view;
determine a distance between the body of the robotic system and the one or more objects based on the portions of the sensor data which senses the body of the robotic system and the one or more objects;
navigate the robotic system until the distance is below a threshold value; and
stop the robotic system.

14. The robotic system of claim 13, wherein,
the sensor comprises a depth camera;
the sensor data corresponds to depth imagery; and
the portion of the sensor data which senses the portion of the body of the robotic system corresponds to pixels of the depth imagery.

15. The robotic system of claim 14, wherein the at least one controller is further configured to execute the computer readable instructions to:
produce a pixel mask, the pixel mask corresponding to pixels of the depth imagery which depict the portion of the body of the robotic system within the field of view; and
update the pixel mask based on the receipt of at least one additional depth image.

16. The non-transitory computer readable storage medium of claim 14, wherein,
the distance between the body of the robotic system body and the one or more objects is measured based on depth values of the depth imagery.

17. The non-transitory computer readable storage medium of claim 15, wherein,
the portion of the body of the robotic system is detected within the depth imagery using at least one of: (i) motion analysis between two or more successive depth images, wherein the portion of the body of the robotic system is stationary; (ii) pixel color analysis between two or more depth images, wherein pixels comprising a large color differential between the two or more images are determined to not correspond to the robotic system; or (iii) expected distances between the depth camera and the robotic system based on calibration values for the depth camera.

18. The non-transitory computer readable storage medium of claim 13, wherein the at least one controller is further configured to execute the computer readable instructions to:
request human assistance using communications units of the robotic system, the request for assistance comprises the robotic system to perform at least one of: (i) emitting an auditory noise; (ii) emitting a visual indication; or (iii) transmitting a signal using a cellular or Wi-Fi network to a device of a human.

19. The robotic system of claim 13, wherein,
the robotic system is a floor cleaning robot.
